(19) United States
(12) Patent Application Publication
(10) Pub. No.: US 2014/0368556 A1
(43) Pub. Date: Dec. 18, 2014

(54) DISPLAY DEVICE

(71) Applicant: Sony Corporation, Tokyo (JP)

(72) Inventors: Yohei Funatsu, Kanagawa (JP); Hidehisa Shimizu, Kanagawa (JP); Shoji Araki, Kanagawa (JP); Yuki Seo, Kanagawa (JP)

(21) Appl. No.: 14/295,974

(22) Filed: Jun. 4, 2014

(30) Foreign Application Priority Data
Jun. 12, 2013 (JP) 2013-123549

(51) Int. Cl. G09G 3/32

(52) U.S. Cl. CPC G09G 3/3225
USPC 345/690; 345/76

(57) ABSTRACT

A display apparatus includes: a display unit that includes a display area including display elements arranged in a two-dimensional matrix and is configured to display an image in the display area based on a video signal; and a correction signal generation unit configured to generate a correction signal that accelerates a change with time for a display element having a small change with time and performs a slowdown or a stop of the change with time for a display element having a large change with time, based on a value of the video signal and time-varying characteristics of a luminance of each display element. When the display apparatus is not used after a normal image is displayed based on the video signal, a corrected image based on the correction signal is displayed to equalize a degree of the change with time of each display element.

### CROSS REFERENCE TO RELATED APPLICATIONS

This application claims the benefit of Japanese Priority Patent Application JP 2013-123549 filed Jun. 12, 2013, the entire contents of which are incorporated herein by reference.

### BACKGROUND

The present disclosure relates to a display apparatus and a driving method for a display apparatus.

A display element equipped with a light-emitting unit and a display apparatus equipped with such a display element are known. For example, a display element equipped with an organic electroluminescent light-emitting unit using electroluminescence (hereinafter, abbreviated to EL in some cases) serving as an organic material draws attention as a display element capable of emitting high luminance light by low-voltage DC (direct current) drive. Hereinafter, such a display element is referred to simply as an organic EL display element in some cases.

In general, the luminance of a display apparatus becomes lower as its operation time becomes longer. Also in the display apparatus using the organic EL display element, a luminance reduction due to, for example, a change with time of a luminous efficiency of the light-emitting unit is observed. In the case where the same pattern is being displayed on the display apparatus for a long time, a luminance change corresponding to the pattern may be observed, that is, so-called image burn-in may occur. When the image burn-in occurs, the display quality of the display apparatus is lowered.

In this regard, the following technique is disclosed: a correction signal for equalizing changes in light emitting characteristics of the display elements is generated and a light emitting element is caused to emit light based on the correction signal in a state where the display apparatus is not used, thus eliminating the problem of the image burn-in. For example, Japanese Patent Application Laid-open No. 2003-228329 discloses that a correction signal is calculated based on maximum and minimum values of an integration value for each pixel of an input video signal.

### SUMMARY

In the configuration in which the correction signal is calculated based on the maximum and minimum values of the integration value for each pixel of the input video signal, the value of the correction signal is calculated without considering deterioration characteristics of the display elements. Hence, from the perspective of equalizing the changes in light-emission characteristics of the display elements, the accuracy of the correction signal is not exactly sufficient, and thus it is thought that effects of improving the display quality are insufficiently provided.

In view of the above-mentioned circumstances, it is desirable to provide a display apparatus and a driving method for a display apparatus, which are capable of accurately equalizing changes in light-emission characteristics of display elements.

According to an embodiment of the present disclosure, there is provided a display apparatus including: a display unit that includes a display area including display elements arranged in a two-dimensional matrix and is configured to display an image in the display area based on a video signal, the display elements each including a current-drive-type light-emitting unit; and a correction signal generation unit configured to generate a correction signal that accelerates a change with time for a display element having a small change with time and performs one of a slowdown and a stop of the change with time for a display element having a large change with time, based on one of a value of the video signal for each of the display elements and a value of the video signal for each predetermined area in the display unit and based on time-varying characteristics of a luminance of each of the display elements, in which when the display apparatus is not used after a normal image is displayed based on the video signal, a corrected image based on the correction signal is displayed to equalize a degree of the change with time of each of the display elements.

According to another embodiment of the present disclosure, there is provided a driving method for a display apparatus, the display apparatus including a display unit that includes a display area including display elements arranged in a two-dimensional matrix and is configured to display an image in the display area based on a video signal, the display elements each including a current-drive-type light-emitting unit, and a correction signal generation unit configured to generate a correction signal that accelerates a change with time for a display element having a small change with time and performs one of a slowdown and a stop of the change with time for a display element having a large change with time, based on one of a value of the video signal for each of the display elements and a value of the video signal for each predetermined area in the display unit and based on time-varying characteristics of a luminance of each of the display elements, the driving method including: displaying, by the display apparatus, when the display apparatus is not used after a normal image is displayed based on the video signal, a corrected image based on the correction signal to equalize a degree of the change with time of each of the display elements.

With the display apparatus and the driving method for a display apparatus according to the embodiments of the present disclosure, the degree of the change with time of each of the display elements is equalized by using the correction signal that accelerates the change with time for a display element having a small change with time and performs a slowdown or a stop of the change with time for a display element having a large change with time, based on the value of the video signal for each of the display elements or for each predetermined area in the display unit and based on time-varying characteristics of a luminance of each of the display elements. This allows the changes in light-emission characteristics of the display elements to be accurately equalized.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a conceptual diagram of a display apparatus according to a first embodiment;

FIG. 2 is a schematic diagram for describing a configuration of a display unit;

FIG. 3 is a schematic graph for describing a relationship between an accumulated operation time of display elements that are operated based on video signals with various gradation values and a change in luminous efficiency of the display elements;

FIG. 4A is a schematic graph for describing a relationship between an operation time and a relative luminance change of the display elements due to deterioration, when the display elements are operated with a varying gradation value of the video signal, and FIG. 4B is a schematic graph for describing a relationship between an operation time and a relative luminance change of the display elements due to a deterioration, when the display elements are operated with varying gradation values of the video signal in different orders;

FIG. 5A is a schematic diagram for describing a correspondence relationship between the segments represented by CL₁, CL₂, CL₃, CL₄, CL₅, and CL₆ in the graph shown in FIG. 4A and the graph shown in FIG. 3, and FIG. 5B is a schematic diagram for describing a correspondence relationship between the segments of curve B represented by CL₁′, CL₂′, CL₃′, CL₄′, CL₅′, and CL₆′ in the graph shown in FIG. 4B and the graph shown in FIG. 3;

FIG. 6A is a diagram schematically showing a state of displaying a test pattern in which the center portion and a circumferential portion of the display area of the display apparatus are displayed in different gradations, and FIG. 6B is a diagram schematically showing an image displayed based on a correction signal for correcting image burn-in caused by the display shown in FIG. 6A;

FIG. 7 is a schematic graph for describing a change with time of light-emission characteristics in a display element corresponding to a point A included in the center portion of the display area and in a display element corresponding to a point B included in the circumferential portion of the display area;

FIG. 8A is a schematic diagram showing a display state of a gradation image on which an on-screen display (OSD) image is superimposed, and FIG. 8B is a diagram schematically showing an image displayed based on a correction signal for correcting image burn-in caused by the display shown in FIG. 8A;

FIG. 9A is a schematic diagram showing a display state of a gray raster image on which an OSD image is superimposed, and FIG. 9B is a diagram schematically showing an image displayed based on a correction signal for correcting image burn-in caused by the display shown in FIG. 9A;

FIG. 10A is a schematic diagram showing a display state of a gray raster image on which an OSD image is superimposed, and FIG. 10B is a diagram schematically showing an image displayed based on a correction signal for correcting image burn-in caused by the display shown in FIG. 10A;

FIG. 11A is a schematic diagram showing a display state of a gray raster image on which an OSD image is superimposed, and FIG. 11B is a diagram schematically showing an image displayed based on a correction signal for correcting image burn-in caused by the display shown in FIG. 11A;

FIG. 12A is a schematic diagram showing a display state of a gray raster image on which a belt-like black OSD image with white parts is superimposed, and FIG. 12B is a diagram schematically showing an image displayed based on a correction signal for correcting image burn-in caused by the display shown in FIG. 12A;

FIG. 13 is a conceptual diagram of a display apparatus according to a first modified example;

FIG. 14 is a conceptual diagram of a display apparatus according to a second modified example; and

FIG. 15 is a schematic diagram for describing a configuration of a display unit according to a modified example.

### DETAILED DESCRIPTION OF EMBODIMENTS

Hereinafter, the present disclosure will be described based on embodiments with reference to the drawings. The present disclosure is not limited to the embodiments, and various numerical values and materials in the embodiments are merely examples. In the following description, components having the same element or function are denoted by the same reference symbol and overlapping description is omitted. Description is given in the following order.

1. General Description on Display Apparatus and Driving Method for Display Apparatus According to Embodiment of Present Disclosure

2. First Embodiment

3. Embodiment of Modified Examples and Others

### General Description on Display Apparatus and Driving Method for Display Apparatus According to Embodiment of Present Disclosure

In a display apparatus according to an embodiment of the present disclosure or a driving method for a display apparatus according to an embodiment of the present disclosure (hereinafter, referred to simply as an embodiment of the present disclosure in some cases), the duration of display of a corrected image based on a correction signal can be fixed to be a predetermined time length. Alternatively, the duration of display of a corrected image based on a correction signal can also be set based on the duration of display of a normal image. The normal image is displayed based on a video signal obtained immediately before the corrected image based on the correction signal is displayed.

The present disclosure including various favorable configurations described above can have a configuration in which a plurality of sets of display elements that emit light of different colors are arranged in a two-dimensional matrix in a display area, and a correction signal generation unit generates correction signals corresponding to the respective colors. According to this configuration, the correction signals appropriate to the display elements of the respective colors are used to equalize the degree of a change with time among the display elements. Consequently, a correction in which a difference in characteristics between the display elements, which involves a difference in color of emitted light, is taken into consideration can be performed. Alternatively, it is possible to provide a configuration in which a plurality of sets of display elements that emit light of different colors are arranged in a two-dimensional matrix in a display area, and a correction signal generation unit generates a correction signal that is used in common with those different colors. For example, in the configuration in which a set of a red display element, a green display element, and a blue display element is provided, a correction signal for the green display element that has a high visibility can be used as a common correction signal. This configuration provides an advantage that the size of a circuit to generate a correction signal can be reduced, for example.

The present disclosure including various favorable configurations described above can have a configuration in which a corrected image is displayed in the entire area of the display area. Alternatively, it is possible to provide a configuration in which the corrected image is displayed exclusively in a predetermined part of the display area. In this case, the corrected image can be displayed in a part of the display area, in which a difference in deterioration degree is large. In contrast to the configuration in which the corrected image is displayed in the entire area of the display area, the configuration in which the corrected image is displayed exclusively in the predetermined part of the display area provides an advantage that power consumption of the display apparatus when the corrected image is displayed can be suppressed.

The present disclosure including various favorable configurations described above can have a configuration in which the corrected image is displayed as a still image or a moving image. For example, it is possible to provide a configuration in which a signal used for a correction is superimposed on an image signal of a moving image as a screen saver and the resultant signal can be used as a correction signal.

The present disclosure can be applied to, for example, a microdisplay used for a head-mounted display and an electronic viewfinder. For example, in a camera equipped with an electronic viewfinder, the camera performs operations of displaying a normal image at the time of imaging and of displaying a corrected image when the imaging is suspended. This allows a user to perform a correction without feeling discomfort. In the head-mounted display, the head-mounted display only needs to perform operations of displaying a normal image in a mounted state and of displaying a corrected image in a non-mounted state. In general, if those devices are driven by batteries, the devices are unavailable during charging in many cases. Thus, it is possible to provide a configuration in which the corrected image can be displayed during the charging by power feeding from the outside. According to this configuration, the corrected image can be displayed by power feeding from the outside. This provides an advantage that a correction can be performed with sufficiently long time.

The correction signal generation unit that forms the display apparatus according to an embodiment of the present disclosure can be constituted of, for example, a storage device and a logic circuit, which can be formed by using a known circuit element and the like. The same holds true for various circuits used for driving a display unit. The functions of the above components may be provided to an integrated semiconductor apparatus.

The display apparatus may be configured to perform so-called monochrome display or may be configured to perform color display. In the color display, one pixel includes a plurality of subpixels. Specifically, one pixel includes three subpixels of a red light emitting subpixel, a green light emitting subpixel, and a blue light emitting subpixel. In addition, one pixel may be constituted of one pixel set including those three types of subpixels and one or a plurality of types of subpixels (for example, one pixel set to which a subpixel that emits white light is added in order to improve a luminance, one pixel set to which a subpixel that emits a complementary color is added in order to enlarge a range of color reproduction, one pixel set to which a subpixel that emits yellow light is added in order to enlarge a range of color reproduction, and one pixel set to which a subpixel that emits yellow light and cyan light is added in order to enlarge a range of color reproduction).

For a pixel value of the display apparatus, some of resolutions for image display, such as resolutions of (1920×1035), (720×480), and (1280×960), in addition to VGA (640×480), S-VGA (800×600), XGA (1024×768), APRC (1152×900), S-XGA (1280×1024), U-XGA (1600×1200), HD-TV (1920×1080), and Q-XGA (2048×1536) standards, can be exemplified, but the resolutions are not limited to those values.

For a current-drive-type light-emitting unit that forms the display element, an organic electroluminescent light-emitting unit, an LED light-emitting unit, a semiconductor laser light-emitting unit, and the like are exemplified. Those light-emitting units can be configured by using a known material and method. In view of the configuration of a flat-screen display apparatus, it is particularly desirable that the light-emitting unit be constituted of an organic electroluminescent light-emitting unit.

The display element that forms the display unit is formed on a certain flat surface (e.g., on a support), and the light-emitting unit is formed on a drive circuit via an interlayer insulating layer, for example. The drive circuit drives the light-emitting unit.

The drive circuit that drives the light-emitting unit can be configured as, for example, a circuit including a transistor and a capacitance unit. For the transistor that forms the drive circuit, for example, a thin-film transistor (TFT) can be exemplified. The configuration of the drive circuit is not particularly limited as long as its operation conforms to the operation of the present disclosure.

Regarding two of source and drain regions of one transistor, the term “one source/drain region” may be used in the sense of a source/drain region connected to a power supply side. Further, the phrase “the transistor is in a conduction state” means a state where a channel is formed between the source and drain regions. Whether a current flows from one of the source and drain regions of such a transistor to the other region is not considered. In contrast, the phrase “the transistor is in a non-conduction state” means a state where a channel is not formed between the source and drain regions. In addition, the source and drain regions can be formed of not only a conductive substance such as amorphous silicon and polysilicon containing impurities but also a layer that is made of metal, an alloy, conductive particles, a laminated structure of them, and an organic material (conductive polymer).

The capacitance unit that forms the drive circuit can be constituted of one electrode, the other electrode, and a dielectric layer sandwiched between those electrodes. The transistor and capacitance unit described above that form the drive circuit are formed on a certain flat surface (e.g., on a support), and the light-emitting unit is formed on the transistor and the capacitance unit, which form the drive circuit, via an interlayer insulating layer, for example. Further, the other one of the source and drain regions of the driving transistor is connected to one end of the light-emitting unit (e.g., to an anode electrode of the light-emitting unit) via a contact hole, for example. It should be noted that the transistor may be formed on a semiconductor substrate or the like.

Various types of wiring including a scanning line WSL and a data line connected to the display element are formed on a certain flat surface (e.g., on a support). Those wiring can have a known configuration or structure.

For constituent materials of the support and the substrate to be described later, glass materials such as glass having a high strain point, a soda glass (Na₂O.CaO.SiO₂), a borosilicate glass (Na₂O.B₂O₃.SiO₂), forsterite (2MgO.SiO₂), and a lead glass (Na₂O.PbO.SiO₂), and flexible polymeric materials including polymeric materials such as polyethersulfone (PES), polyimide, polycarbonate (PC), and polyethylene terephthalate (PET) can be exemplified. It should be noted that various types of coating may be formed on the surfaces of the support and the substrate. The constituent materials of the support and the substrate may be the same or different. The use of the support and the substrate made of the flexible polymeric material provides a flexible display apparatus.

Conditions shown in various expressions in this specification are satisfied in the case where the expressions are established mathematically rigorously and also in the case where the expressions are practically established. Regarding the establishment of the expressions, variations caused due to the design or production of the display element and the display apparatus are admissible.

In the graphs and the like used for the following description, the length of a horizontal axis or a vertical axis is a schematic one, and the proportion corresponding to the length is not shown. Additionally, waveforms in the graphs and the like are also schematic ones.

### First Embodiment

A first embodiment according to the present disclosure relates to a display apparatus, a driving method for a display apparatus, and a signal output circuit.

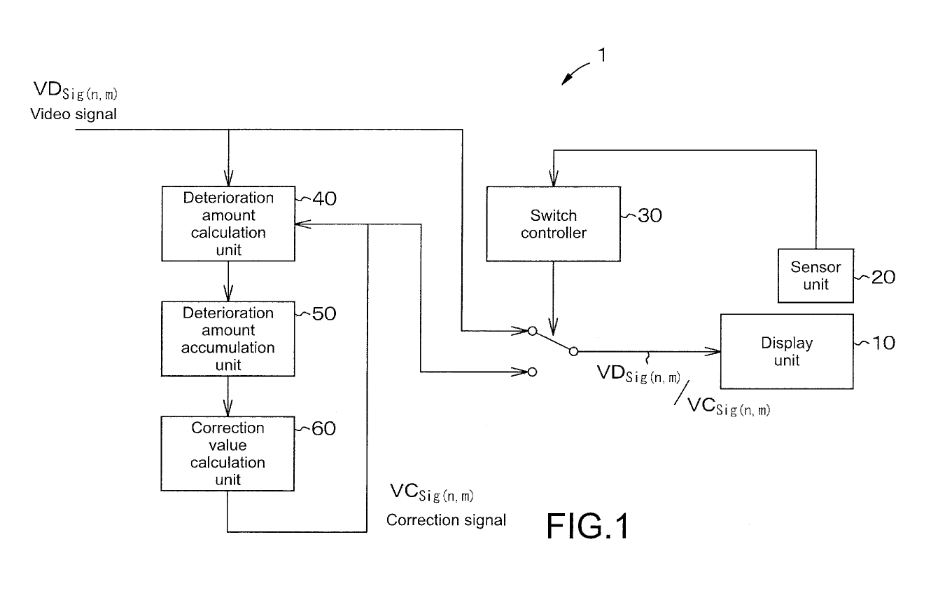

FIG. 1 is a conceptual diagram of a display apparatus according to the first embodiment.

A display apparatus 1 is a display apparatus that forms, for example, an electronic viewfinder for a video camera.

The display apparatus 1 includes a display unit 10 and a correction signal generation unit. The display unit 10 has a display area in which display elements each including a current-drive-type light-emitting unit are arranged in a two-dimensional matrix, and displays an image in the display area based on a video signal. The correction signal generation unit generates a correction signal that accelerates a change with time for a display element having a small change with time and slows or stops a change with time for a display element having a large change with time, based on a value of a video signal for each display element or for each predetermined area in the display unit 10 and based on time-varying characteristics of a luminance of the display element. The correction signal generation unit includes a deterioration amount calculation unit 40, a deterioration amount accumulation unit 50, and a correction value calculation unit 60.

Additionally, the display apparatus 1 includes a sensor unit 20 and a switch controller 30. The sensor unit 20 is provided near the display unit 10. The switch controller 30 switches a signal to be sent to the display unit 10, based on the signal supplied from the sensor unit 20, between a video signal VD_{Sig} and a correction signal VC_{Sig} that will be described later. The sensor unit 20 is a so-called occupancy sensor or may be a known sensor. Based on the signal supplied from the sensor unit 20, when a user looks through an electronic viewfinder, the video signal VD_{Sig} is sent to the display unit 10, and when the user does not look through the electronic viewfinder, the correction signal VC_{Sig} is sent to the display unit 10. The whole of the display apparatus 1 is controlled by a control circuit (not shown) and the like.

The outline of the configuration of the correction signal generation unit will be described. For example, the video signal VD_{Sig} that is sent from a camera unit (not shown) and the correction signal VC_{Sig} to be described later are input to the deterioration amount calculation unit 40. The deterioration amount calculation unit 40 refers to a characteristic curve stored in advance and calculates a deterioration amount of the display element, based on a gradation value of a signal when the display element is driven, the operation time of the display element, and the like. The deterioration amount accumulation unit 50 accumulates the deterioration amount calculated by the deterioration amount calculation unit 40 and stores values of the accumulated deterioration amounts. The operation described above can be performed for each display element or for each predetermined area in the display unit 10. For convenience of the description, in the following description, it is assumed that a predetermined operation is performed for each display element. The correction value calculation unit 60 generates such a correction signal that accelerates a change with time for a display element having a small change with time and slows or stops a change with time for a display element having a large change with time, based on the values stored in the deterioration amount accumulation unit 50 and the like.

For convenience of the description on the operation, the display unit 10 will first be described. The configuration of the correction signal generation unit will be described later.

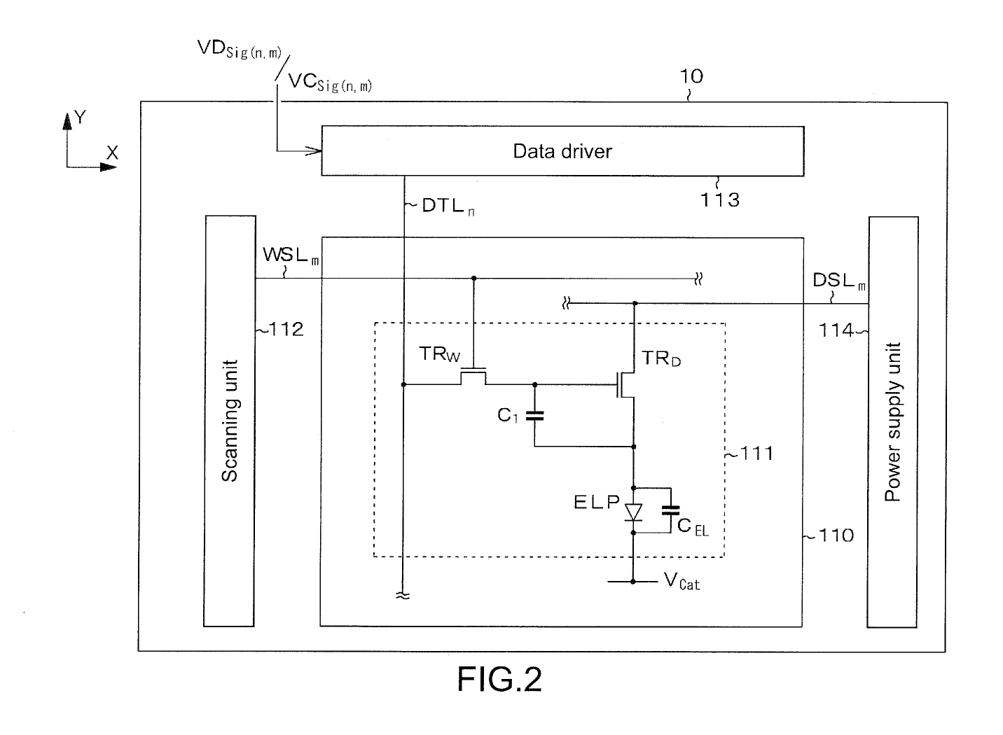

FIG. 2 is a schematic diagram for describing a configuration of the display unit 10.

The display unit 10 includes a display area 110. In the display area 110, display elements 111 each including a current-drive-type light-emitting unit ELP and a drive circuit that drives the light-emitting unit ELP are arranged in a two-dimensional matrix in a state of being connected to a scanning line WSL, an electric supply line DSL, and a data line DTL. The scanning line WSL and the electric supply line DSL extend in a row direction (X direction in FIG. 2), and the data line DTL extends in a column direction (Y direction in FIG. 2). Additionally, the display unit 10 includes a scanning unit 112, a data driver 113, and a power supply unit 114. The scanning unit 112 supplies a scanning signal to the scanning line WSL. The data driver 113 applies a voltage to the data line DTL. The power supply unit 114 supplies a voltage for driving the display element 111 to the electric supply line DSL. The light-emitting unit ELP that forms the display element 111 is constituted of an organic electroluminescent light-emitting unit, for example. For convenience of the illustration, FIG. 2 shows a wire connection of one display element, and more specifically, of an (n, m)-th display element 111 that will be described later.

Though not shown in FIG. 2, an area in which the display unit 10 displays an image, that is, the display area 110, includes the total of N×M display elements 111 (N display elements 111 in the row direction by M display elements 111 in the column direction) that are arranged in a two-dimensional matrix. The number of rows of the display elements 111 in the display area 110 is M, and the number of display elements 111 in each row is N.

Further, each of the number of scanning lines WSL and the number of electric supply lines DSL are M. The display elements 111 in the m-th row (where m=1, 2, . . . , and M) are connected to the m-th scanning line WSLₘ and the m-th electric supply line DSLₘ and form one row of the display elements. It should be noted that FIG. 2 shows only the scanning line WSLₘ and the electric supply line DSLₘ.

Furthermore, the number of data lines DTL is N. The display elements 111 in the n-th column (where n=1, 2, . . . , and N) are connected to the n-th data line DTLₙ. It should be noted that FIG. 2 shows only the data line DTLₙ.

In the display apparatus 1, for example, a set of display elements that emit light with different colors of red, green, and blue forms one pixel. With the scanning signal from the scanning unit 112, the display apparatus 1 is subjected to line sequential scanning on a row-by-row basis. The display element 111 located in the m-th row and the n-th column is hereinafter referred to as the (n, m)-th display element or the (n, m)-th pixel. If a set of display elements 111 that emit red, green, and blue light and are arranged adjacently to one another in the same row forms one pixel, the number of pixels of the display area 110 is (N/3)×M.

In the display apparatus 1, the display elements 111 that form the N pixels arranged in the m-th row are simultaneously driven. In other words, a timing of light emission/non-emission of the N display elements 111 arranged along the row direction is controlled in units of the row to which those display elements 111 belong. When a display frame rate of the display apparatus 1 is represented by FR (number of times/seconds), a scanning period per row when the display apparatus 1 is subjected to line sequential scanning on a row-by-row basis, that is, a so-called horizontal scanning period, is less than (1/FR)×(1/M) seconds.

The data driver 113 of the display apparatus 1 receives inputs of a video signal VD_{Sig} derived from imaging and a correction signal VC_{Sig} that will be described later, for example. In the video signal VD_{Sig} and the correction signal VC_{Sig}, a signal corresponding to the (n, m)-th display element 111 may be represented as a video signal VD_{Sig(n, m)} and a correction signal VD_{Sig(n, m)}.

For convenience of the description, the gradation bit number of the video signal VD_{Sig} and the correction signal VC_{Sig} is assumed to be 9 bits. A gradation value is any value of 0 to 511. A larger gradation value provides a higher luminance to an image to be displayed. It should be noted that the gradation bit number described above is merely an example. For example, the gradation bit number may be 4 bits, 8 bits, 12 bits, 16 bits, and 24 bits.

The display element 111 includes at least a current-drive-type light-emitting unit ELP, a write transistor TR_{W}, a drive transistor TR_{D}, and a capacitance unit C₁. When a current flows through the light-emitting unit ELP via the source and drain regions of the drive transistor TR_{D}, the display element 111 emits light.

The capacitance unit C₁ is used to hold a voltage of a gate electrode with respect to the source region of the drive transistor TR_{D}, that is, what is called a gate-source voltage. In the light emission state of the display element 111, one of the source and drain regions of the drive transistor TR_{D} (i.e., the side connected to the electric supply line DSL in FIG. 2) works as a drain region, and the other one of the source and drain regions of the drive transistor TR_{D} (i.e., the side connected to one end of the light-emitting unit ELP, more specifically, to the anode electrode) works as a source region. One electrode and the other electrode that form the capacitance unit C₁ are connected to the other one of the source and drain regions and the gate electrode of the drive transistor TR_{D}, respectively.

The write transistor TR_{W} includes a gate electrode that is connected to the scanning line WSL, one of source and drain regions that is connected to the data line DTL, and the other one of the source and drain regions that is connected to the gate electrode of the drive transistor TR_{D}.

The gate electrode of the drive transistor TR_{D} is connected to the other one of the source and drain regions of the write transistor TR_{W} and to the other electrode of the capacitance unit C₁. The other one of the source and drain regions of the drive transistor TR_{D} is connected to the one electrode of the capacitance unit C₁ and the anode electrode of the light-emitting unit ELP.

The other end of the light-emitting unit ELP (specifically, a cathode electrode) is applied with a common voltage V_{Cat} such as a ground voltage. Further, the capacitance of the light-emitting unit ELP is represented by C_{EL}.

The data driver 113 generates a voltage corresponding to the gradation value and supplies the voltage to the data line DTL. When the write transistor TR_{W} enters a conduction state by a scanning signal supplied from the scanning unit 112 with the voltage corresponding to the gradation value being supplied to the data line DTL, the voltage corresponding to the gradation value is written to the capacitance unit C₁. After the write transistor TR_{W} enters a non-conduction state, a current flows through the drive transistor TR_{D} according to the voltage held in the capacitance unit C₁, so that the light-emitting unit ELP emits light.

Subsequently, a change with time of a luminance in the display element will be described.

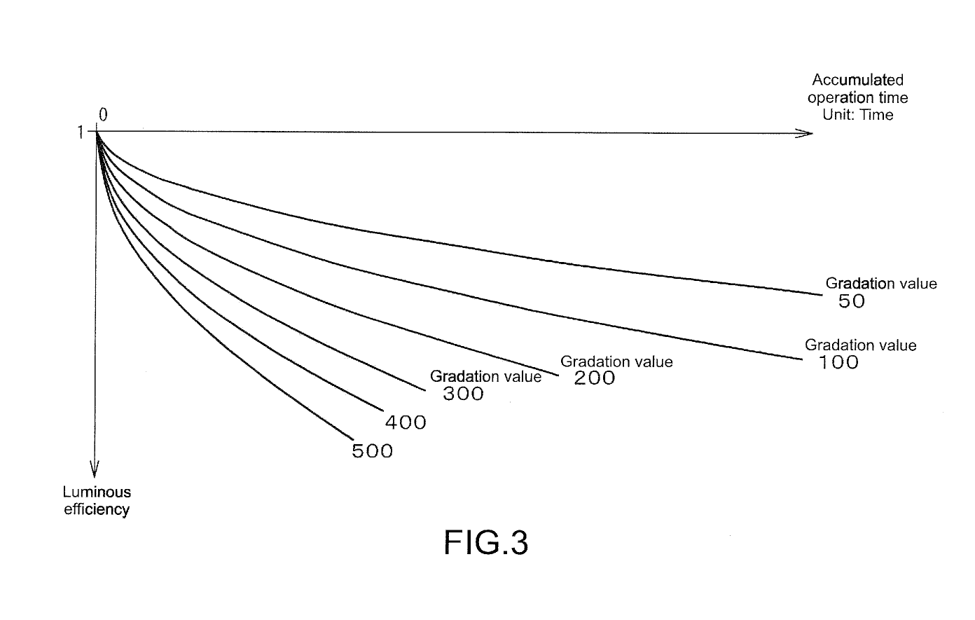

FIG. 3 is a schematic graph for describing a relationship between an accumulated operation time of the display elements 111 that are operated based on video signals with various gradation values and a change in luminous efficiency of the display elements 111.

Detailed description on the graph of FIG. 3 will be given. In the display apparatus 1 in the initial state, first to sixth areas included in the display area 110 are operated based on the video signals VD_{Sig} having respective gradation values of 50, 100, 200, 300, 400, and 500, and the length of the accumulated operation time and a ratio of a luminance after a change with time to a luminance in the initial state in the display elements 111 forming the first to sixth areas are determined. Subsequently, the length of the accumulated operation time is plotted as values of the horizontal axis, and the ratio of the luminance after the change with time to the luminance in the initial state in the display elements 111 in the divided areas is plotted as values of the vertical axis.

The values on the vertical axis of the graph shown in FIG. 3 correspond to the values of the luminous efficiency, which are obtained by normalizing the initial state as “1”. As obviously found from the graph, a larger gradation value of the video signal VD_{Sig} provides a larger degree of a relative luminance change with respect to the luminance in the initial state. Similarly, a longer accumulated operation time increases the degree of the relative luminance change with respect to the luminance in the initial state.

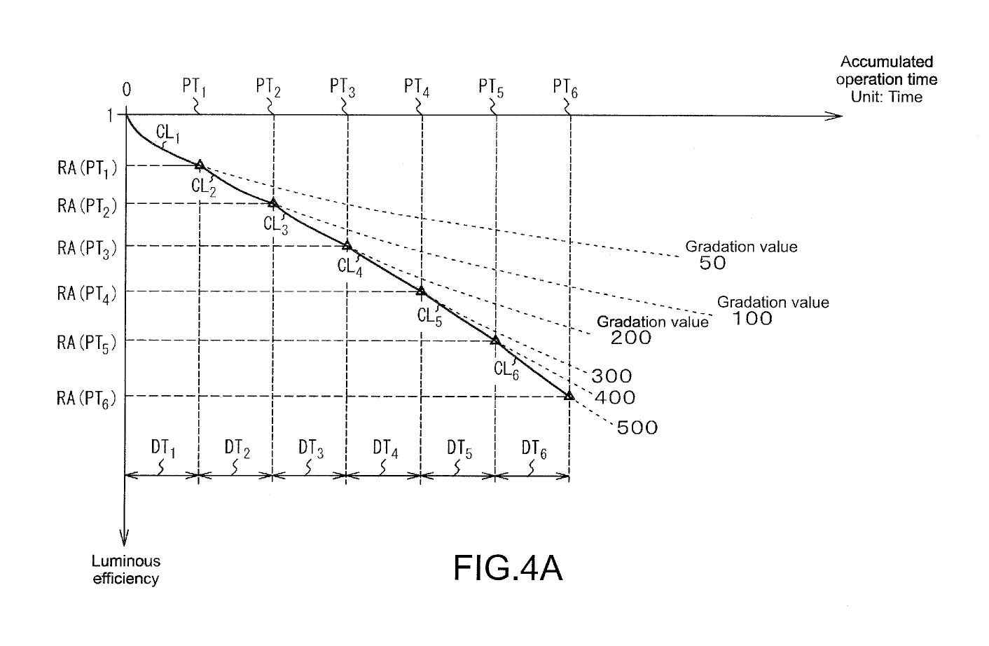

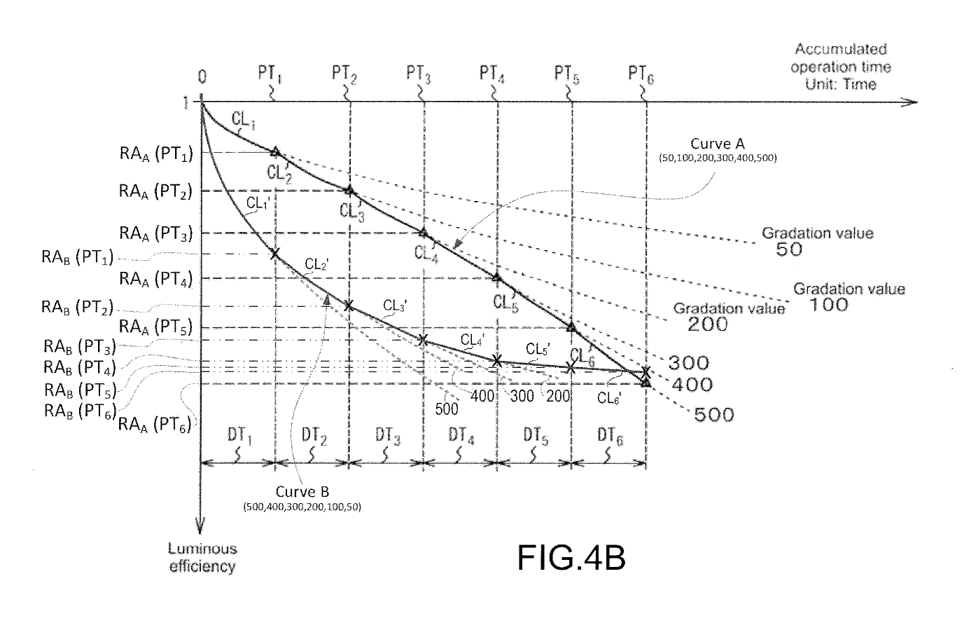

Consequently, the degree of the luminance change (deterioration) in the display element 111 depends on the gradation value of the video signal VD_{Sig} when the display element 111 is operated and on the length of the operation time of the display element 111. The effect on the deterioration of the display element 111 when it is operated with a varying gradation value of the video signal VD_{Sig} will be described with reference to FIGS. 4A and 4B.

FIG. 4A is a schematic graph for describing a relationship between an operation time and a relative luminance change of the display elements due to deterioration, when the display elements are operated with a varying gradation value of the video signal.

Specifically, the graph shown in FIG. 4A is a graph in which the length of the accumulated operation time is plotted as values of the horizontal axis, and a ratio of a luminance after deterioration to a luminance in the initial state of the display element 111 is plotted as values of the vertical axis, based on data when the display elements 111 in the initial state are operated based on the video signals VD_{Sig} having a gradation value 50 in an operation time DT₁, a gradation value 100 in an operation time DT₂, a gradation value 200 in an operation time DT₃, a gradation value 300 in an operation time DT₄, a gradation value 400 in an operation time DT₅, and a gradation value 500 in an operation time DT₆.

In FIG. 4A, reference symbols PT₁, PT₂, PT₃, PT₄, PT₅, and PT₆ each indicate a value of the accumulated operation time at that time. The time PT₆ equals the sum of the operation times DT₁ through DT₆.

In FIG. 4A, values on the vertical axis that correspond to the time PT₁, PT₂, PT₃, PT₄, PT₅, and PT₆ are represented by RA(PT₁), RA(PT₂), RA(PT₂), RA(PT₄), RA(PT₅), and RA(PT₆), respectively. Further, in the curve shown in FIG. 4A, a segment from time 0 to time PT₁, a segment from time PT₁ to time PT₂, a segment from time PT₂ to time PT₃, a segment from time PT₃ to time PT₄, a segment from time PT₄ to time PT₅, and a segment from time PT₅ to time PT₆ are represented by CL₁, CD₂, CD₃, CD₄, CD₅, and CL₆, respectively. The curve shown in FIG. 4A can be described as a curve constructed by appropriately connecting some segments obtained from the curves shown in FIG. 3.

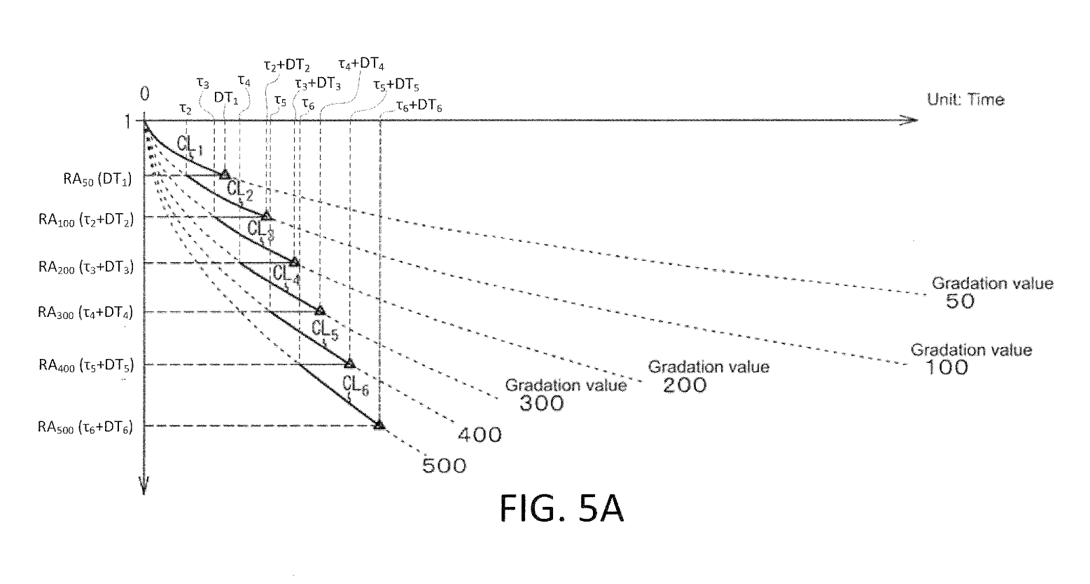

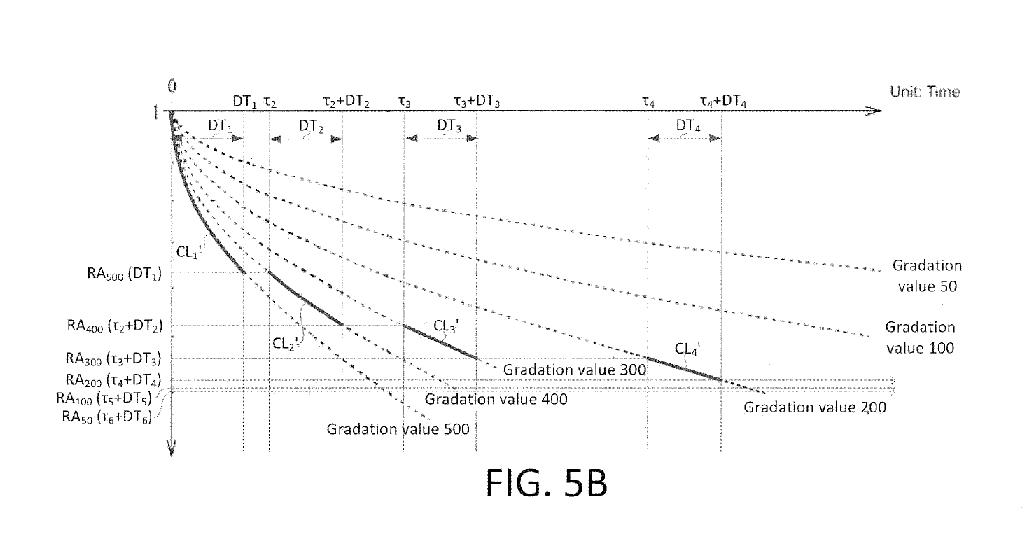

FIG. 5A is a schematic diagram for describing a correspondence relationship between the segments represented by CL₁, CL₂, CL₃, CL₄, CL₅, and CL₆ in the graph shown in FIG. 4A and the graph shown in FIG. 3.

As shown in FIG. 5A, the segment represented by CL₁ in the graph shown in FIG. 4A corresponds to a segment of the gradation value 50 curve of FIG. 3 in the range from 1 to RA₅₀(DT₁) on the vertical axis. That is, from the time 0 to the time PT₁ the deterioration of the pixel circuit in FIG. 4A is determined by the gradation value 50 curve. The duration of the display at gradation value 50 is DT₁, and therefor the endpoint of the segment CL₁ is the point where the gradation value 50 curve has the deterioration value of RA₅₀(DT₁).

The segment represented by CL₂ in the graph shown in FIG. 4A corresponds to a segment of the gradation value 100 curve of FIG. 3 in the range from RA₅₀(DT₁) to RA₁₀₀(τ₂+DT₂) on the vertical axis. That is, from the time PT₁ to the time PT₂ the deterioration of the pixel circuit is determined by the gradation value 100 curve. When display at gradation value 100 begins, the pixel already has deteriorated to RA₅₀ (DT₁) due to the display from time 0 to PT₁, and therefore segment CL₂ begins at the point where the gradation value 100 curve has the deterioration value of RA₅₀ (DT_{I}). The time value corresponding to this point is designated above by τ, where RA₁₀₀(τ₂)=RA₅₀(DT₁). As can be seen, τ₂≠DT₁, since the gradation value 50 and gradation value 100 curves have different deterioration rates. The display at gradation value 100 occurs for a period of time equal to DT₂, and therefore the end point of the segment CL₂ is the point where the gradation value 100 curve has the deterioration value of RA₄₀₀(τ₂+DT₂).

Similarly, each of the segments CL₃ through CL₆ can be obtained by tracing the appropriate gradation curve by a time amount equal to the respectively corresponding display duration DT₃ through DT₆. Beginning points of the segments CL₃ through CL₆ are the points where their corresponding gradation curves take the value equal to the cumulative deterioration up to that point resulting from previous display. These beginning points correspond to the time values τ₃ through τ₆, respectively, in FIG. 5A. Ending points of the segments CL₃ through CL₆ are obtained by tracing the respective curves, and correspond to the times (τ₃+DT₃) through (τ₆+DT₆) in the graph of FIG. 5A. Thus, the segment represented by CL₃ in the graph shown in FIG. 4A corresponds to a segment of the gradation value 200 curve of FIG. 3 in the range from RA₂₀₀(τ₃) to RA₂₀₀(τ₃+DT₃) on the vertical axis. In the same manner, the segment represented by CL₄ in the graph shown in FIG. 4A corresponds to a segment of the gradation value 300 curve of FIG. 3 in the range from RA₃₀₀(τ₄) to RA₃₀₀(τ₄+DT₄) on the vertical axis. The segment represented by CL₅ in the graph shown in FIG. 4A corresponds to a segment of the gradation value 400 curve of FIG. 3 in the range from RA₄₀₀(τ₅) to RA₄₀₀(τ₅+DT₅) on the vertical axis. The segment represented by CL₆ in the graph shown in FIG. 4A corresponds to a segment of the gradation value 500 curve of FIG. 3 in the range from RA₅₀₀(τ₆) to RA₅₀₀(τ₆+DT₆) on the vertical axis.

Consequently, such parameters as the gradation values and operation time when the display element 111 is driven are sequentially compared with the graph shown in FIG. 3, so that a cumulative change in luminous efficiency (cumulative deterioration) of the display element 111 can be calculated.

FIG. 4B is a schematic graph for describing a relationship between an operation time and a relative luminance change of the display elements due to a deterioration, when the display elements are operated with varying gradation values of the video signal in different orders.

Specifically, the graph shown in FIG. 4B is a graph in which the length of the accumulated operation time is plotted as values of the horizontal axis, and a ratio of a luminance after a change with time to a luminance in the initial state of the display element 111 (deterioration) is plotted as values of the vertical axis. In the graph of FIG. 4B, two curves are shown: curve A is identical to the curve shown in FIG. 4A, in which the display element is operated at gradation values in an order of 50, 100, 200, 300, 400, and 500; for curve B, on the other hand, the display element is operated at gradation values in an opposite order, namely 500, 400, 300, 200, 100, and 50. Thus, for curve B the pixel circuit is operated based on the video signals VD_{Sig} having a gradation value 500 in an operation time DT₁, a gradation value 400 in an operation time DT₂, a gradation value 300 in an operation time DT₃, a gradation value 200 in an operation time DT₄, a gradation value 100 in an operation time DT₅, and a gradation value 50 in an operation time DT₆.

In FIG. 4B, reference symbols PT₁, PT₂, PT₃, PT₄, PT₅, and PT₆ each indicate a value of the accumulated operation time at that time. The time PT₆ equals a sum of the operation times DT₁ through DT₆.

In FIG. 4B, values on the vertical axis that correspond to the time PT₁, PT₂, PT₃, PT₄, PT₅, and PT₆ are represented by RA_{A}(PT₁), RA_{A} (PT₂), RA_{A} (PT₃), RA_{A} (PT₄), RA_{A} (PT₅), and RA_{A} (PT₆), respectively for curve A and RA_{B}(PT₁), RA_{B} (PT₂), RA_{B} (PT₃), RA_{B} (PT₄), RA_{B} (PT₅), and RA_{B} (PT₆), respectively for curve B. Further, a segment from time 0 to time PT₁, a segment from time PT₁ to time PT₂, a segment from time PT₂ to time PT₃, a segment from time PT₃ to time PT₄, a segment from time PT₄ to time PT₅, and a segment from time PT₅ to time PT₆ are represented by CL₁, CL₂, CL₃, CL₄, CL₅, and CL₆, respectively for curve A and by CL₁′, CL₂′, CL₃′, CL₄′, CL₅′, and CL₆′, respectively for curve B. The curves shown in FIG. 4B can be described as curves constructed by appropriately connecting some segments of the curves shown in FIG. 3.

FIG. 5B is a schematic diagram for describing a correspondence relationship between the segments of curve B represented by CL₁′, CL₂′, CL₃′, CL₄′, CL₅′, and CL₆′ in the graph shown in FIG. 4B and the graph shown in FIG. 3.

As shown in FIG. 5B, the segment represented by CL₁′ in the graph shown in FIG. 4B corresponds to a segment of the gradation value 500 curve of FIG. 3 in the range from 1 to RA₅₀₀(DT₁) on the vertical axis. That is, from the time 0 to the time PT₁ the deterioration of the pixel circuit for curve B is determined by the gradation value 500 curve. The duration of the display at gradation value 500 is DT₁, and therefor the endpoint of the segment CL₁′ is the point where the gradation value 500 curve has the deterioration value of RA₅₀₀(DT₁).

The segment represented by CL₂ in the graph shown in FIG. 4B corresponds to a segment of the gradation value 400 curve of FIG. 3 in the range from RA₅₀₀(DT₁) to RA₄₀₀(τ₂+DT₂) on the vertical axis. That is, from the time PT₁ to the time PT₂ the deterioration of the pixel circuit for curve is determined by the gradation value 400 curve. When display at gradation value 400 begins, the pixel already has deteriorated to RA₅₀₀(DT₁) due to the display from time 0 to PT₁, and therefore segment CL₂′ begins at the point where the gradation value 400 curve has the deterioration value of RA₅₀₀ (DT₁). The time value corresponding to this point is designated above by τ₂, where RA₄₀₀(τ₂)=RA₅₀₀(DT₁). The display at gradation value 400 occurs for a period of time equal to DT₂, and therefore the end point of the segment CL₂′ is the point where the gradation value 400 curve has the deterioration value of RA₄₀₀(τ₂+DT₂).

Similarly, each of the segments CL₃′ through CL₆′ can be obtained by tracing the appropriate gradation curve by a time amount equal to the respectively corresponding display duration DT₃ through DT₆. Beginning points of the segments CL₃′ through CL₆′ are the points where their corresponding gradation curves take the value equal to the cumulative deterioration up to that point resulting from previous display. These beginning points correspond to the time values τ₃ through τ₆, respectively, in FIG. 5B. Ending points of the segments CL₃′ through CL₆′ are obtained by tracing the respective curves, and correspond to the times (τ₃+DT₃) through (τ₆+DT₆) in the graph of FIG. 5B. Thus, the segment represented by CL₃′ in the graph shown in FIG. 4B corresponds to a segment of the gradation value 300 curve of FIG. 3 in the range from RA₃₀₀(τ₃) to RA₃₀₀(τ₃+DT₃) on the vertical axis. In the same manner, the segment represented by CL₄′ in the graph shown in FIG. 4B corresponds to a segment of the gradation value 200 curve of FIG. 3 in the range from RA₂₀₀(τ₄) to RA₂₀₀(τ₄+DT₄) on the vertical axis. The segment represented by CL₅′ in the graph shown in FIG. 4B corresponds to a segment of the gradation value 100 curve of FIG. 3 in the range from RA₄₀₀(τ₅) to RA₄₀₀(τ₅+DT₅) on the vertical axis. The segment represented by CL₆′ in the graph shown in FIG. 4B corresponds to a segment of the gradation value 50 curve of FIG. 3 in the range from RA₅₀(τ₆) to RA₅₀(τ₆+DT₆) on the vertical axis.

Consequently, such parameters as the gradation values and operation time when the display element 111 is driven are sequentially compared with the graph shown in FIG. 3, so that a change in luminous efficiency of the display element 111 can be calculated.

As can be seen by comparing curves A and B shown in FIG. 4B, a deterioration amount for a pixel may depend upon more than a brightness integration value for the pixel. In particular, the pixels corresponding to curves A and B both have the same brightness integration value for the time period 0 to PT₆, since they both displayed at gradations of 50, 100, 200, 300, 400, and 500 for a unit amount of time. However, because the orders in which the pixels corresponding to curves A and B displayed the gradations differed, the total deterioration of the pixels also differed. Thus, a correction signal that is based on only brightness integration values may not adequately correct for the deterioration of certain pixels.

The deterioration amount calculation unit 40 shown in FIG. 1 calculates individual characteristic change amounts in the operations in the segments denoted by CL₁, CL₂, CL₃, CL₄, CL₅, and CL₆ shown in FIG. 4A and the segments denoted by CL₁′, CL₂′, CL₃′, CL₄′, CL₅′, and CL′₆ shown in 4B, for example. The deterioration amount accumulation unit 50 shown in FIG. 1 holds the total sum of the individual characteristic change amounts.

The time degradation of the display device

Subsequently, the operation of the display apparatus 1 will be described.

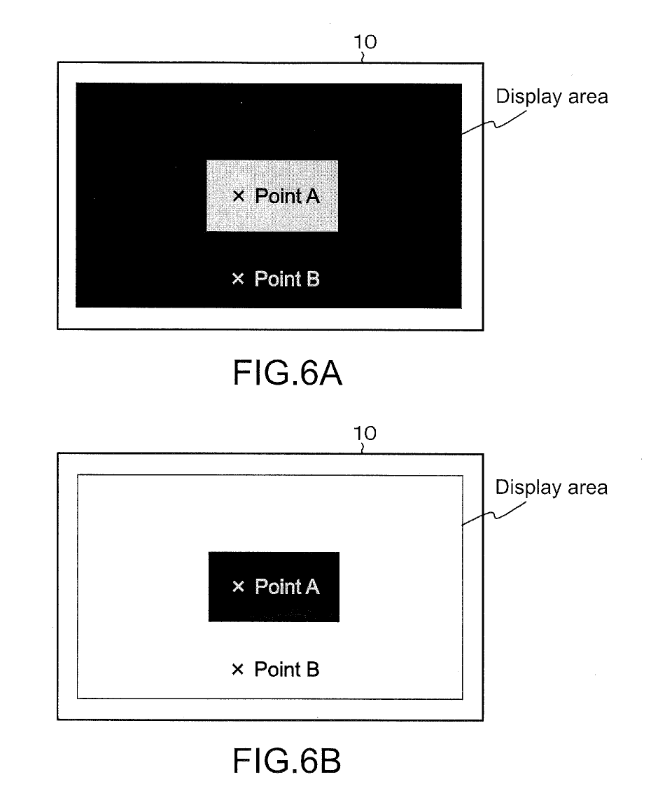

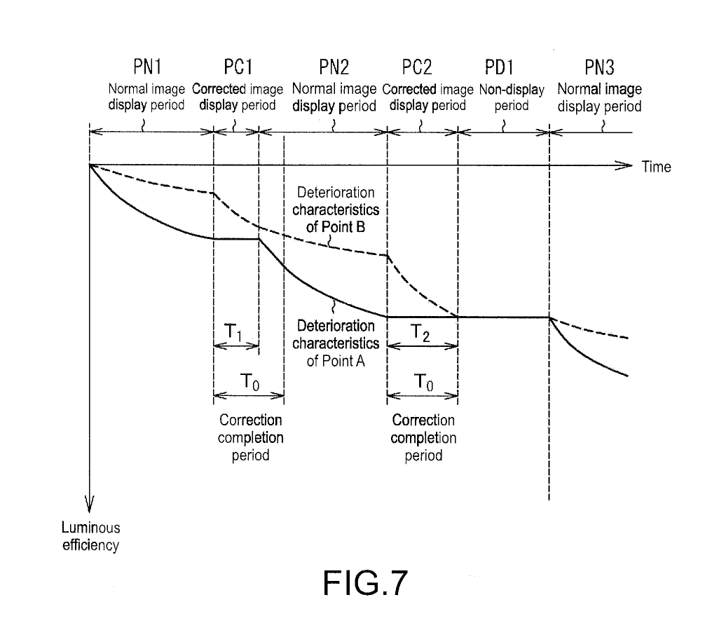

FIG. 6A is a diagram schematically showing a state of displaying a test pattern in which the center portion and a circumferential portion of the display area of the display apparatus are displayed in different gradations. FIG. 6B is a diagram schematically showing an image displayed based on a correction signal for correcting image burn-in caused by the display shown in FIG. 6A. FIG. 7 is a schematic graph for describing a change with time of light-emission characteristics in a display element corresponding to a point A included in the center portion of the display area and a display element corresponding to a point B included in the circumferential portion of the display area.

As shown in FIG. 6B, a corrected image is described as being displayed in the entire area of the display area 110, but the present disclosure is not limited to this. For example, the corrected image may be displayed exclusively in a predetermined part of the display area 110. In particular, the corrected image may be displayed in a part of the display area 110, in which a difference in deterioration degree is large.

Here, the duration of display of the corrected image based on a correction signal is described as being fixed to be a predetermined time length T₀. It is desirable to set the time length T₀ to a certain length, from the perspective of equalizing changes in light-emission characteristics of the display elements 111 by displaying the corrected image. Depending on the degree of image burn-in, for example, the time length T₀ can be set to about several minutes to several tens of minutes or can be set to a further longer time. The correction value calculation unit 60 shown in FIG. 1 determines the value of the correction signal VC_{Sig}, based on the time length T₀ and the deterioration amount in each display element, so that the changes in light-emission characteristics of the display elements 111 are equalized by displaying the corrected image in the time length T₀.

The correction signal generation unit may be configured to generate a correction signal corresponding to each color and may be configured to generate a correction signal used in common with the different colors. Here, the correction signal VC_{Sig} is generated for each display element. In other words, the correction signal generation unit generates a correction signal corresponding to each color.

The operation time of the display unit 10 can be roughly divided into a normal image display period, a corrected image display period, and a non-display period. The normal image display period is a period of time in which the image shown in FIG. 6A is displayed. The corrected image display period is a period of time in which the image shown in FIG. 6B is displayed. The non-display period may be a period of time in which the entire screen is displayed in black or may be a period of time in which the operation of the display unit 10 is stopped, for example.

FIG. 7 shows an example in which operations are performed in a first normal image display period PN1, a first corrected image display period PC1, a second normal image display period PN2, a second corrected image display period PC2, a first non-display period PD1, and a third normal image display period PN3.

In the normal image display period, the change with time is advanced differently at the point A and the point B. Specifically, the change with time of the point A that is displayed with a relatively higher gradation is advanced faster than that of the point B.

After the first normal image display period PN1, the first corrected image display period PC1 starts, for example, when a user moves away from the electronic viewfinder.

The length of the first corrected image display period PC1 is represented by T₁. Here, it is assumed that T₁<T₀. Specifically, in this case, the user looks through the electronic viewfinder before the first corrected image display period PC1 ends.

In the first corrected image display period PC1, T₁<T₀. Consequently, the second normal image display period PN2 starts before the change with time of the light-emission characteristics of the display elements 111 are equalized.

In the second normal image display period PN2, the change with time is advanced differently at the point A and the point B in the state where the difference in change with time between the display elements 111 in the final stage of the first corrected image display period PC1 is left.

After the second normal image display period PN2, the second corrected image display period PC2 starts, for example, when the user moves away from the electronic viewfinder again. Here, it is assumed that the user is away from the electronic viewfinder for a sufficiently long time.

The correction value calculation unit 60 shown in FIG. 1 determines the value of the correction signal VC_{Sig} so as to equalize the changes in light-emission characteristics of the display elements 111 by displaying the corrected image in the time length T₀ in consideration of the difference in change with time between the display elements 111 in the final stage of the first corrected image display period PC1.

The length of the second corrected image display period PC2 is represented by T₂. It should be noted that T₂=T₀.

In the second corrected image display period PC2, the period of time in which the corrected image is displayed is sufficiently ensured, and thus the change with time of the point A and that of the point B are equalized by displaying of the corrected image.

If a state where the user does not look through the electronic viewfinder is continued, the non-display period PD1 starts after the second corrected image display period PC2. Here, for example, it is assumed that the operation of the display unit 10 is stopped. Consequently, each of the point A and the point B is not changed with time and keeps its previous state.

Subsequently, when the user looks through the electronic viewfinder, the third normal image display period PN3 starts. Hereinafter, the operations described above are appropriately repeated.

Hereinabove, the operation of the display apparatus 1 has been described with reference to FIG. 7. It should be noted that a blank period may be provided between the final stage of the normal image display period and an initial stage of the corrected image display period for the purpose of preparation to display the corrected image, for example. The preparation to display the corrected image is, for example, an operation to calculate an optimum corrected image corresponding to a deterioration state of each of the point A and the point B and display such a corrected image.

The display apparatus 1 is a low-cost and small-sized apparatus having high correction accuracy and high reliability. In the normal image display period, a video signal is displayed without change, and thus a normal image can be displayed rapidly after the display apparatus is activated. Consequently, the display apparatus 1 is suitable for an electronic apparatus for which a quick activation is expected.

In the above description, the duration of display of the corrected image is fixed to be a predetermined time length T₀. However, the duration of display of the corrected image may not be fixed. For example, the duration of display of the corrected image based on the correction signal may be set based on the duration of display of a normal image. The normal image is displayed based on a video signal obtained immediately before the corrected image based on the correction signal is displayed.

Herein, a period of time spent for completion of the correction on all pixels is referred to as a “correction completion period”. As described above, for the correction completion period, a fixed value or a variable value is assumed to be set. In the case where the light-emitting unit that forms the display element is an organic electroluminescent light-emitting unit, the deterioration of the light-emitting unit is more accelerated as a gradation value becomes higher and as a ratio of a period in which the light-emitting unit emits light in one frame period (hereinafter, the ratio is referred to as a “light emission duty”) becomes larger. The one frame period is given by a reciprocal of a display frame rate FR (number of times/seconds). In other words, the deterioration of the light-emitting unit is advanced in a relatively shorter time as the gradation value becomes higher or as the light emission duty becomes larger. Using as a reference a deterioration of the light-emitting unit when the light-emitting unit emits light at a predetermined reference gradation value and a predetermined reference light emission duty, an acceleration factor of a deterioration time when the light-emitting unit emits light at different gradation values is often obtained as a power of a gradation ratio and takes a non-linear value. In contrast to this, an acceleration factor of a deterioration time when the light-emitting unit emits light at different light emission duties takes a substantially linear value. The operation shown in FIG. 7 shows a case where the correction completion period is set to a fixed value. In order to set the same value for the first and second correction completion periods T₀, a display gradation in a correction period, a light emission duty, and a display time of each pixel are considered, and a correction pattern is determined. It should be noted that the following configuration may be provided: light emission is not necessarily successive in a light emission period of each pixel, and black display is inserted in a pulse-like manner. Here, in order to set the correction completion period T₀ to be constant irrespective of the magnitude of the difference in deterioration amount at the start of the correction and an absolute value of the deterioration amount, it is necessary to set a long correction completion period T₀ assuming that a case where the difference in deterioration amount is large and an absolute value of the deterioration amount is small is the worst case. After the correction completion period T₀ is set to be long, the gradation and the light emission duty are reduced and black display is intermittently inserted in a display pattern accordingly. This allows the correction completion period T₀ to be fixed. On the other hand, as an example in which the correction completion period is not fixed, a case where a correction is completed fastest will be described. In order to complete a correction fastest, the deterioration of a pixel with the least deterioration only needs to be accelerated at maximum. Thus, the display apparatus 1 only needs to be driven in such a manner that the gradation of that pixel is made maximum, the light emission duty is made maximum, and black display is not inserted in a display pattern. In this case, the correction completion period fluctuates due to a difference in deterioration amount at the start of the correction, an absolute value of the deterioration amount, and the like, and thus the correction completion period does not take a fixed value.

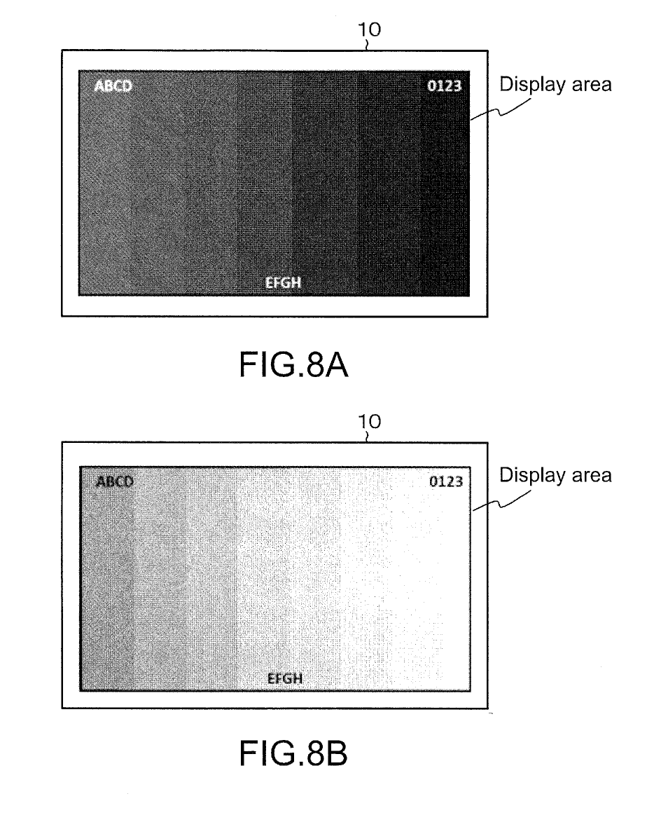

The present disclosure may be conceived to be practically used to correct image burn-in caused due to fixed display, when an image on which an on-screen display (OSD) image is superimposed is displayed. Examples of the image when such display is performed will be described with reference to FIGS. 8 to 12.

FIG. 8A is a schematic diagram showing a display state of a gradation image on which an OSD image is superimposed. FIG. 8B is a diagram schematically showing an image displayed based on a correction signal for correcting image burn-in caused by the display of FIG. 8A.

In such a manner, as a display gradation in the normal image display period becomes lower, a display gradation in the corrected image is set to be higher in order to accelerate the deterioration in the correction period.

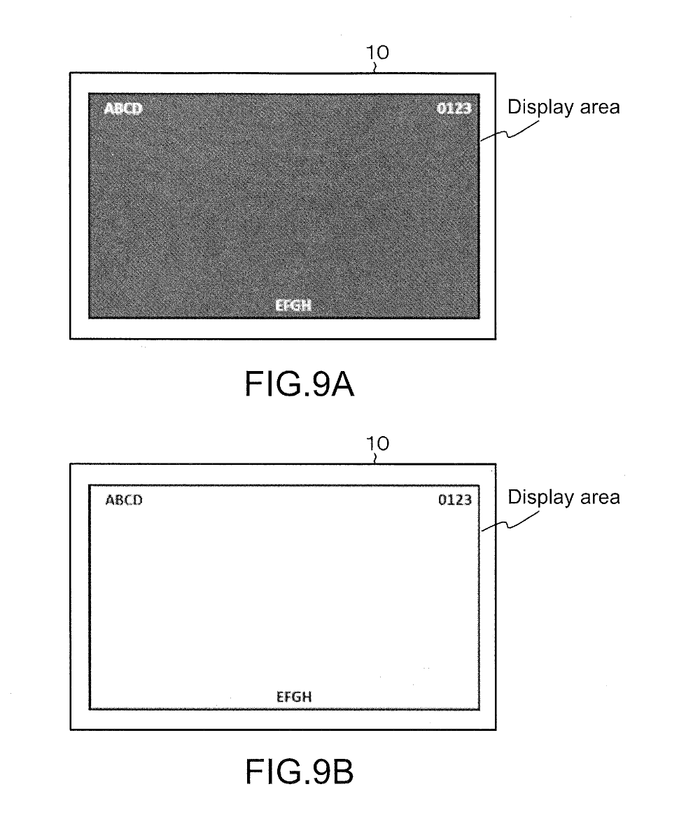

FIG. 9A is a schematic diagram showing a display state of a gray raster image on which an OSD image is superimposed. FIG. 9B is a diagram schematically showing an image displayed based on a correction signal for correcting image burn-in caused by the display shown in FIG. 9A.

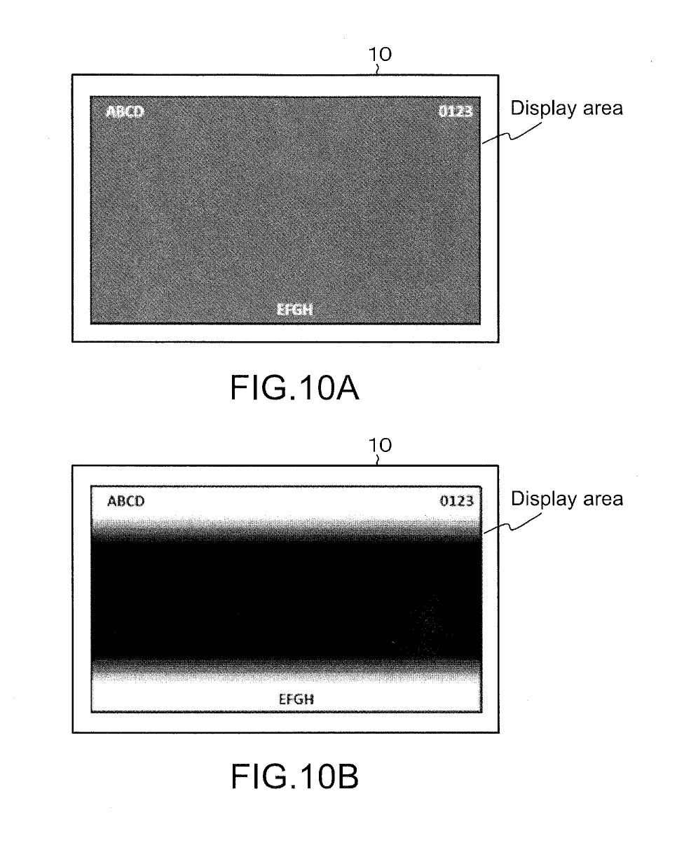

In the corrected image at that time, most pixels emit light at a high gradation. Consequently, in this case, an increase in power consumption in a correction period or a problem of visibility due to the high luminance light emission may be caused. An example to eliminate those problems is shown in FIGS. 10A and 10B.

FIG. 10A is a schematic diagram showing a display state of a gray raster image on which an OSD image is superimposed. FIG. 10B is a diagram schematically showing an image displayed based on a correction signal for correcting image burn-in caused by the display shown in FIG. 10A.

The image is divided into an area where an OSD image is not superimposed and an area where the OSD image is superimposed, and boundaries between those areas are depicted with gradation in such a manner that a difference in luminance is not visually recognized with ease.

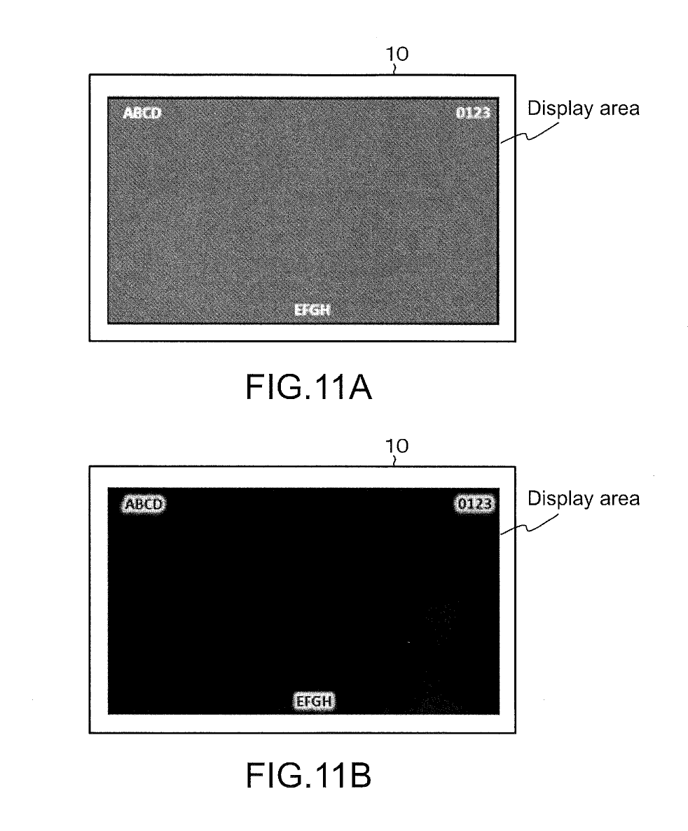

An example to further reduce power consumption due to the display of a corrected image is shown in FIGS. 11A and 11B.

FIG. 11A is a schematic diagram showing a display state of a gray raster image on which an OSD image is superimposed. FIG. 11B is a diagram schematically showing an image displayed based on a correction signal for correcting image burn-in caused by the display shown in FIG. 11A.

In this example, only parts located near the boundaries of the OSD image are displayed with high gradation. Correction is exclusively performed on high-frequency components that tend to be recognized as image burn-in. This allows a reduction in area where light is emitted with a high luminance and in power consumption in a display period of the corrected image.

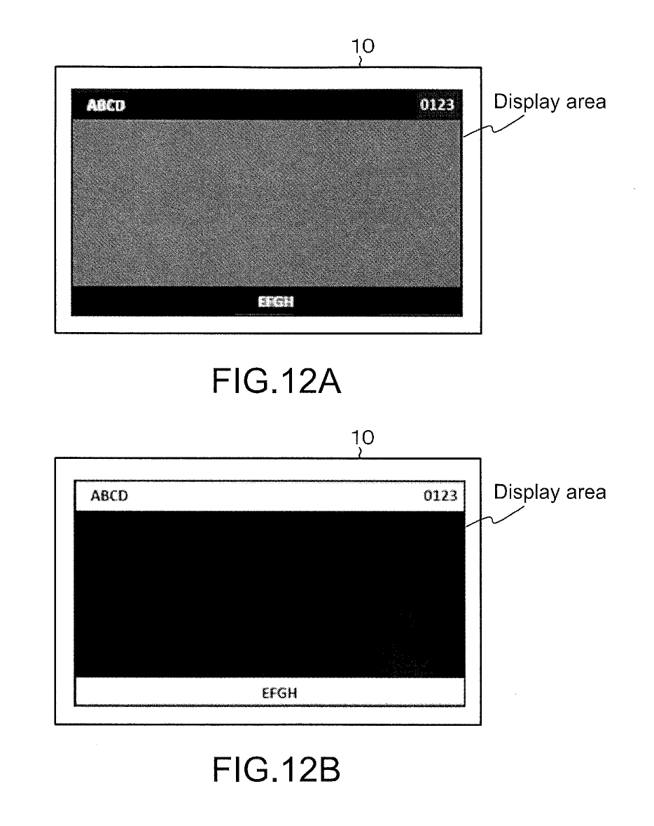

FIG. 12A is a schematic diagram showing a display state of a gray raster image on which a belt-like black OSD image with white parts is superimposed. FIG. 12B is a diagram schematically showing an image displayed based on a correction signal for correcting image burn-in caused by the display shown in FIG. 12A.

This example shows a case where the OSD image in the normal image display is the belt-like black image with white parts. In this case, an area from which light is emitted with a high luminance is limited without using the correction pattern with the gradation as described above, and the power consumption in the corrected image display period can be reduced.

Subsequently, a first modified example will be described.

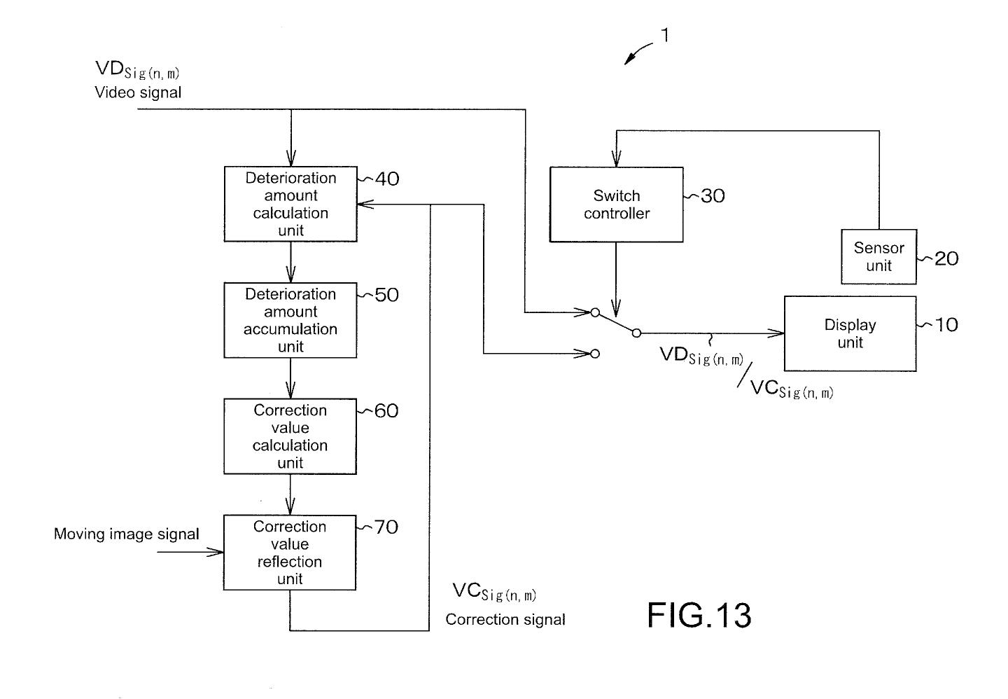

FIG. 13 is a conceptual diagram of a display apparatus according to a first modified example.

In the example shown in FIG. 13, at a subsequent stage of the correction value calculation unit 60, a correction value reflection unit 70 is additionally provided. For example, a moving image signal prepared as a screen saver is supplied to the correction value reflection unit 70. The correction value reflection unit 70 generates a correction signal on which the moving image signal prepared as a screen saver is superimposed.

According to this configuration, a corrected image is displayed as a moving image. Consequently, an uncomfortable feeling caused by the display of the corrected image can be reduced. It is desirable to provide the moving image signal as an image in which the whole of the display elements is uniformly changed with time.

Subsequently, a second modified example will be described.

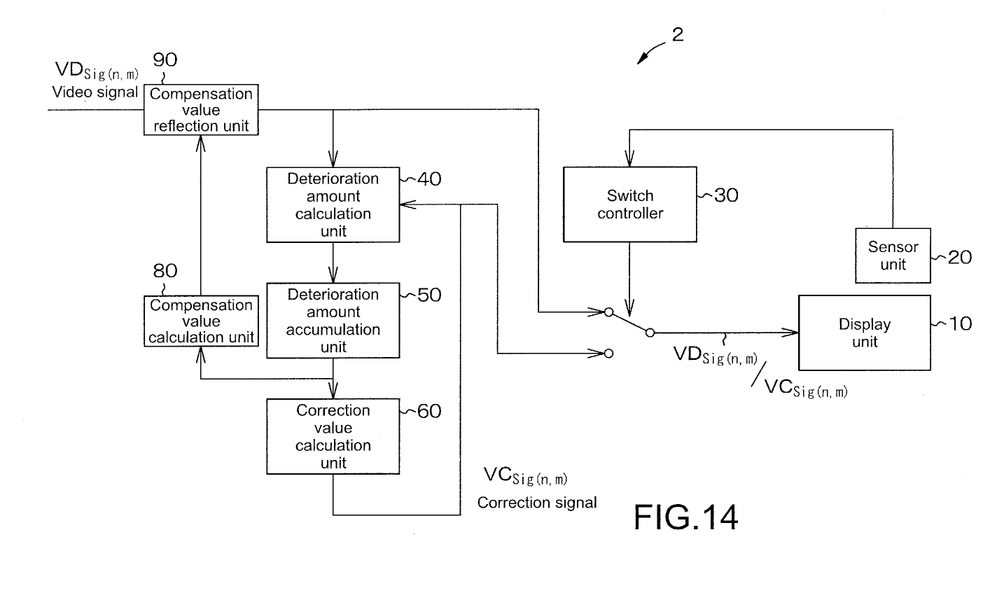

FIG. 14 is a conceptual diagram of a display apparatus according to a second modified example.

In the first embodiment described with reference to FIG. 1, the changes in light-emission characteristics of the display elements can be equalized. However, as the display apparatus is used longer, the luminance of the displayed image is reduced more.

In view of this fact, in the second modified example, a gradation value of a video signal VD_{Sig} is changed so as to compensate for the reduction in luminance of the displayed image. Specifically, a compensation value calculation unit 80 and a compensation value reflection unit 90 are added to the configuration of FIG. 1. The compensation value calculation unit 80 calculates, based on the value of the deterioration amount accumulation unit 50, a change amount of a gradation value of a video signal corresponding to each display element. Subsequently, the compensation value reflection unit 90 reflects a predetermined factor and the like on the input video signal VD_{Sig}, to compensate for the reduction in luminance of the displayed image.

It should be noted that the reduction in luminance of the displayed image can be compensated without changing the video signal VD_{Sig}.

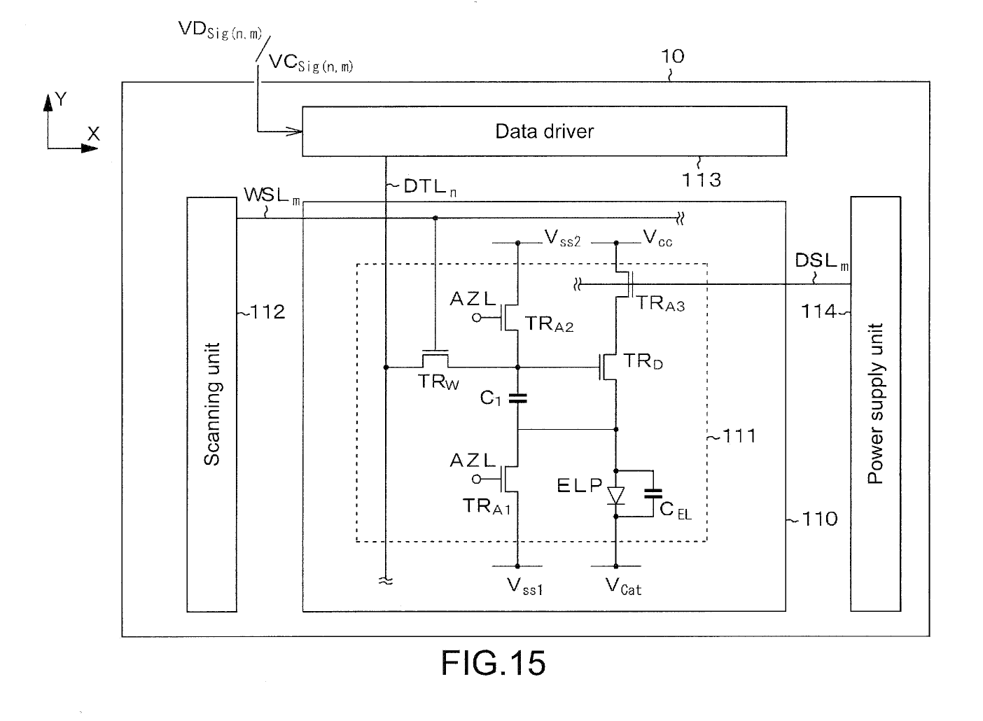

FIG. 15 is a schematic diagram for describing a configuration of a display unit according to a modified example.

In a display element 111 shown in FIG. 15, initialization transistors TR_{A1} and TR_{A2} that initialize a voltage between a source and a drain of the drive transistor, and a light emission control transistor TR_{A3} that is arranged between the drive transistor TR_{D} and the power supply V_{cc} are added to the configuration of FIG. 2.

In the configuration shown in FIG. 15, a period in which the light emission control transistor TR_{A3} is in a conduction state is changed, and thus a ratio of a period in which the light-emitting unit ELP emits light in one frame period can be controlled. In other words, when the period in which the light emission control transistor TR_{A3} is in the conduction state is elongated, the luminance of the light-emitting unit ELP is increased. When the period in which the light emission control transistor TR_{A3} is in the conduction state is shortened, the luminance of the light-emitting unit ELP is reduced.

Consequently, if the period in which the light emission control transistor TR_{A3} is in the conduction state is controlled to be elongated more as a period in which the display apparatus is used becomes longer, the reduction in luminance of a displayed image can be compensated.

Hereinabove, the embodiments of the present disclosure have been specifically described, but the present disclosure is not limited to the above-mentioned embodiments and can be variously modified based on the technical idea of the present disclosure. For example, numerical values, structures, substrates, materials, processes, and the like described in the above embodiments are merely examples, and different numerical values, structures, substrates, materials, processes, and the like may be used as necessary.

It should be noted that the technology of the present disclosure can take the following configurations.

(1) A display apparatus, including:

a display unit that includes a display area including display elements arranged in a two-dimensional matrix and is configured to display an image in the display area based on a video signal, the display elements each including a current-drive-type light-emitting unit; and

a correction signal generation unit configured to generate a correction signal that accelerates a change with time for a display element having a small change with time and performs one of a slowdown and a stop of the change with time for a display element having a large change with time, based on one of a value of the video signal for each of the display elements and a value of the video signal for each predetermined area in the display unit and based on time-varying characteristics of a luminance of each of the display elements, in which

when the display apparatus is not used after a normal image is displayed based on the video signal, a corrected image based on the correction signal is displayed to equalize a degree of the change with time of each of the display elements.

(2) The display apparatus according to (1), in which

a duration of display of the corrected image based on the correction signal is fixed to be a predetermined time length.

(3) The display apparatus according to (1), in which

a duration of display of the corrected image based on the correction signal is set based on a duration of display of the normal image, the normal image being displayed based on the video signal obtained immediately before the corrected image based on the correction signal is displayed.

(4) The display apparatus according to any one of (1) to (3), in which

the display area includes sets of the display elements that emit light of different colors and are arranged in a two-dimensional matrix, and

the correction signal generation unit is configured to generate a correction signal that corresponds to each color.

(5) The display apparatus according to any one of (1) to (3), in which

the display area includes sets of the display elements that emit light of different colors and are arranged in a two-dimensional matrix, and

the correction signal generation unit is configured to generate a correction signal that is used in common with each color.

(6) The display apparatus according to any one of (1) to (5), in which

the corrected image is displayed on an entire area of the display area.

(7) The display apparatus according to any one of (1) to (5), in which

the corrected image is displayed exclusively in a predetermined part of the display area.

(8) The display apparatus according to (7), in which

the corrected image is displayed in a part of the display area, the part having a large difference in degree of deterioration.

(9) The display apparatus according to any one of (1) to (8), in which

the corrected image is displayed as one of a still image and a moving image.

(10) A driving method for a display apparatus, the display apparatus including

a display unit that includes a display area including display elements arranged in a two-dimensional matrix and is configured to display an image in the display area based on a video signal, the display elements each including a current-drive-type light-emitting unit, and

a correction signal generation unit configured to generate a correction signal that accelerates a change with time for a display element having a small change with time and performs one of a slowdown and a stop of the change with time for a display element having a large change with time, based on one of a value of the video signal for each of the display elements and a value of the video signal for each predetermined area in the display unit and based on time-varying characteristics of a luminance of each of the display elements,

the driving method including:

displaying, by the display apparatus, when the display apparatus is not used after a normal image is displayed based on the video signal, a corrected image based on the correction signal to equalize a degree of the change with time of each of the display elements.

It should be understood by those skilled in the art that various modifications, combinations, sub-combinations and alterations may occur depending on design requirements and other factors insofar as they are within the scope of the appended claims or the equivalents thereof.

(11) A display apparatus, comprising

a display unit that includes a display area including display elements arranged in a two-dimensional matrix and is configured to display an image in the display area based on a display signal, the display elements each including a current-drive-type light-emitting unit, the display signal being a video signal when a normal image is displayed and being a correction signal when a correction image is displayed to equalize a degree of luminance deterioration of the display elements; and

a correction signal generation unit configured to determine a cumulative luminance deterioration amount for each of the display elements and generate the correction signal based on the cumulative deterioration amounts such that display of the correction image accelerates luminance deterioration for those display elements having a small cumulative luminance deterioration amount and slows down or stops luminance deterioration for those display elements having a large cumulative luminance deterioration amount.

(12) The display apparatus of (11),
wherein the correction image is displayed in a period in which the display apparatus is not being used for normal image display.
(13) The display apparatus of any one of (11) and (12), further comprising:
a sensor configured to sense whether the display apparatus is being used for normal image display, and
a control unit configured to control which of the normal image and the correction image is displayed based on the sensor's output.
(14) The display apparatus of any one of (11) through (13), wherein the correction signal generation unit determines the cumulative luminance deterioration amount for each of the display elements based on values of the display signal for the respective display element and on one or more corresponding luminance deterioration functions.
(15) The display apparatus of any one of (11) through (14),
wherein the correction signal generation unit determines the cumulative luminance deterioration amount for each of the display elements by updating a cumulative luminance deterioration value for each of the display elements each time a value of the display signal is input to the respective display element, where the updating is accomplished by:
determining an incremental luminance deterioration value for the respective display element based on the display signal and on one or more corresponding luminance deterioration functions; and
incrementing the cumulative luminance deterioration value for the respective display element by the incremental luminance deterioration value for the respective display element.
(16) The display apparatus of any one of (11) through (15),
wherein, each time that the correction image is displayed during a correction image display period, the correction signal generation unit generates the correction signal based on a corresponding correction completion period value that is a target value for the duration of the respective correction image display period.
(17) The display apparatus of any one of (11) through (16),
wherein the correction completion period value is a fixed value.
(18) The display apparatus of any one of (11) through (16),
wherein the correction completion period value is determined by the correction signal generation unit based on a duration of a display of the normal image prior to the display of the respective correction image.
(19) The display of any one of (11) through (18),
wherein the display elements include a plurality of subsets, each subset emitting light of a different color than the other subset, and
the correction signal generation unit is configured to generate a separate correction signal for each color of light emitted by the display elements.
(20) The display apparatus of any one of (11) through (19),
wherein the display elements include a plurality of subsets, each subset emitting light of a different color than the other subset, and
the correction signal generation unit is configured to generate a common correction signal for all of the display elements.
(21) The display apparatus of any one of (11) through (20), wherein the corrected image is displayed on an entire area of the display area.
(22) The display apparatus of any one of (11) through (20), wherein the corrected image is displayed exclusively in a predetermined part of the display area.
(23) The display apparatus of (22), wherein the predetermined part of the display area has a relatively large amount of cumulative luminance deterioration compared to a remainder of the display area.
(24) The display apparatus of any one of (11) through (23), wherein the corrected image is displayed as one of a still image and a moving image.
(25) An electronic apparatus comprising the display apparatus of any one of (11) through (24).
(26) A head mounted display apparatus comprising an eyeglass type frame mountable to a user's head and the display apparatus of any one of (11) through (24) connected to the eyeglass type frame.
(27) The head mounted display apparatus of 26, further comprising:
a sensor configured to sense whether the head mounted display apparatus is mounted to a user's head in a position for normal image display, and
a control unit configured to control which of the normal image and the correction image is displayed based on the sensor's output such that the correction image is displayed only in a period in which the display apparatus is not mounted to a user's head in a position for normal image display.
(28) A display apparatus, comprising:

a display unit that includes a display area including display elements arranged in a two-dimensional matrix and is configured to display an image in the display area based on a display signal, the display elements each including a current-drive-type light-emitting unit, the display signal being a video signal when a normal image is displayed and being a correction signal when a correction image is displayed to equalize a degree of luminance deterioration of the display elements; and

a correction signal generation unit configured to: determine a cumulative luminance deterioration amount for each of the display elements based on values of the display signal for the respective display element and on one or more corresponding luminance deterioration functions;

generate the correction signal based on the cumulative deterioration amounts such that display of the correction image accelerates luminance deterioration for those display elements having a small cumulative luminance deterioration amount and slows down or stops luminance deterioration for those display elements having a large cumulative luminance deterioration amount.
(29) A display apparatus, comprising:

a display unit that includes a display area including display elements arranged in a two-dimensional matrix and is configured to display an image in the display area based on a display signal, the display elements each including a current-drive-type light-emitting unit, the display signal being a video signal when a normal image is displayed and being a correction signal when a correction image is displayed to equalize a degree of luminance deterioration of the display elements; and

a correction signal generation unit configured to: update a cumulative luminance deterioration value for each of the display elements when a value of the display signal is input to the respective display element by:

determining an incremental luminance deterioration value for the respective display element based on the display signal and on one or more corresponding luminance deterioration functions; and
incrementing the cumulative luminance deterioration value for the respective display element by the incremental luminance deterioration value for the respective display element; and
generate the correction signal based on the cumulative deterioration values such that display of the correction image accelerates luminance deterioration for those display elements having a small cumulative luminance deterioration value and slows down or stops luminance deterioration for those display elements having a large cumulative luminance deterioration value.
(30) A display apparatus, comprising:

a display unit that includes a display area including display elements arranged in a two-dimensional matrix and is configured to display an image in the display area based on a display signal, the display elements each including a current-drive-type light-emitting unit, the display signal being a video signal when a normal image is displayed and being a correction signal when a correction image is displayed to equalize a degree of luminance deterioration of the display elements; and

a correction signal generation unit configured to determine a cumulative luminance deterioration amount for each of predetermined regions of the display area and generate the correction signal based on the cumulative deterioration amounts such that display of the correction image accelerates luminance deterioration for the display elements in those predetermined regions having a small cumulative luminance deterioration amount and slows down or stops luminance deterioration for the display elements of those predetermined regions having a large cumulative luminance deterioration amount.

(31) An electronic apparatus comprising:
a display unit including a display area; and
a battery unit,
wherein the display area is configured to display a normal image and a correction image, and
wherein the correction image is displayed during charging the battery unit.
(32) The electronic apparatus of (31), wherein the display unit is an electronic viewfinder using an organic EL display element.
(33) The electronic apparatus of (32), wherein a video signal for display of the normal image is sent to the display unit when the user looks through the electronic viewfinder, and a correction signal for display of the correction image is sent to the display unit when the user does not look through the electronic viewfinder.
(34) The electronic apparatus of any one of (31) through (32), wherein the display area includes at least a first part and a second part which is more deteriorated than the first part, and the correction image is formed such that the first part of the display area displays higher luminance than the second part of the display area.
(35) The electronic apparatus of any one of (31) through (34), further comprising:
a sensor configured to sense a user, and
a control unit configured to control which of the normal image and the correction image is displayed based on the sensor's output.
(36) The electronic apparatus of (35), wherein the sensor is arranged near the display unit to be able to detect a user.
(37) The electronic apparatus of any one of (31) through (36) further comprising:
a control unit configured to supply a display signal to the display unit; and
a sensor configured to supply a detection signal to the control unit,
wherein the display unit is configured to display an image in the display area based on a display signal that is a video signal when the normal image is displayed and a correction signal when the correction image is displayed, and
wherein the control unit is configured to switch the display signal between the video signal and the correction signal and the display area is configured to change between displaying the normal image and displaying the correction image based on the detection signal.

What is claimed is:

1. A display apparatus, comprising:
a display unit that includes a display area including display elements arranged in a two-dimensional matrix and is configured to display an image in the display area based on a video signal, the display elements each including a current-drive-type light-emitting unit; and
a correction signal generation unit configured to generate a correction signal that accelerates a change with time for a display element having a small change with time and performs one of a slowdown and a stop of the change with time for a display element having a large change with time, based on one of a value of the video signal for each of the display elements and a value of the video signal for each predetermined area in the display unit and based on time-varying characteristics of a luminance of each of the display elements, wherein
when the display apparatus is not used after a normal image is displayed based on the video signal, a corrected image based on the correction signal is displayed to equalize a degree of the change with time of each of the display elements.

2. The display apparatus according to claim 1, wherein
a duration of display of the corrected image based on the correction signal is fixed to be a predetermined time length.

3. The display apparatus according to claim 1, wherein
a duration of display of the corrected image based on the correction signal is set based on a duration of display of the normal image, the normal image being displayed based on the video signal obtained immediately before the corrected image based on the correction signal is displayed.

4. The display apparatus according to claim 1, wherein
the display area includes sets of the display elements that emit light of different colors and are arranged in a two-dimensional matrix, and
the correction signal generation unit is configured to generate a correction signal that corresponds to each color.

5. The display apparatus according to claim 1, wherein
the display area includes sets of the display elements that emit light of different colors and are arranged in a two-dimensional matrix, and
the correction signal generation unit is configured to generate a correction signal that is used in common with each color.

6. The display apparatus according to claim 1, wherein
the corrected image is displayed on an entire area of the display area.

7. The display apparatus according to claim 1, wherein
the corrected image is displayed exclusively in a predetermined part of the display area.

8. The display apparatus according to claim 7, wherein
the corrected image is displayed in a part of the display area, the part having a large difference in degree of deterioration.

9. The display apparatus according to claim 1, wherein
the corrected image is displayed as one of a still image and a moving image.

10. A driving method for a display apparatus, the display apparatus including
a display unit that includes a display area including display elements arranged in a two-dimensional matrix and is configured to display an image in the display area based on a video signal, the display elements each including a current-drive-type light-emitting unit, and
a correction signal generation unit configured to generate a correction signal that accelerates a change with time for a display element having a small change with time and performs one of a slowdown and a stop of the change with time for a display element having a large change with time, based on one of a value of the video signal for each of the display elements and a value of the video signal for each predetermined area in the display unit and based on time-varying characteristics of a luminance of each of the display elements,
the driving method comprising:
displaying, by the display apparatus, when the display apparatus is not used after a normal image is displayed based on the video signal, a corrected image based on the correction signal to equalize a degree of the change with time of each of the display elements.

11. A display apparatus, comprising:
a display unit that includes a display area including display elements arranged in a two-dimensional matrix and is configured to display an image in the display area based on a display signal, the display elements each including a current-drive-type light-emitting unit, the display signal being a video signal when a normal image is displayed and being a correction signal when a correction image is displayed to equalize a degree of luminance deterioration of the display elements; and
a correction signal generation unit configured to determine a cumulative luminance deterioration amount for each of the display elements and generate the correction signal based on the cumulative deterioration amounts such that display of the correction image accelerates luminance deterioration for those display elements having a small cumulative luminance deterioration amount and slows down or stops luminance deterioration for those display elements having a large cumulative luminance deterioration amount.

12. The display apparatus of claim 11,
wherein the correction image is displayed in a period in which the display apparatus is not being used for normal image display.

13. The display apparatus of claim 12, further comprising:
a sensor configured to sense whether the display apparatus is being used for normal image display, and
a control unit configured to control which of the normal image and the correction image is displayed based on the sensor's output.

14. The display apparatus of claim 11,
wherein the correction signal generation unit determines the cumulative luminance deterioration amount for each of the display elements based on values of the display signal for the respective display element and on one or more corresponding luminance deterioration functions.

15. The display apparatus of claim 11,
wherein the correction signal generation unit determines the cumulative luminance deterioration amount for each of the display elements by updating a cumulative luminance deterioration value for each of the display elements each time a value of the display signal is input to the respective display element, where the updating is accomplished by:
determining an incremental luminance deterioration value for the respective display element based on the display signal and on one or more corresponding luminance deterioration functions; and
incrementing the cumulative luminance deterioration value for the respective display element by the incremental luminance deterioration value for the respective display element.

16. The display apparatus of claim 11,
wherein, each time that the correction image is displayed during a correction image display period, the correction signal generation unit generates the correction signal based on a corresponding correction completion period value that is a target value for the duration of the respective correction image display period.

17. The display apparatus of claim 16,
wherein the correction completion period value is a fixed value.

18. The display apparatus of claim 16,
wherein the correction completion period value is determined by the correction signal generation unit based on a duration of a display of the normal image prior to the display of the respective correction image.

19. The display apparatus according to claim 11,
wherein the display elements include a plurality of subsets, each subset emitting light of a different color than the other subset, and
the correction signal generation unit is configured to generate a separate correction signal for each color of light emitted by the display elements.

20. The display apparatus according to claim 11,
wherein the display elements include a plurality of subsets, each subset emitting light of a different color than the other subset, and
the correction signal generation unit is configured to generate a common correction signal for all of the display elements.

21. The display apparatus according to claim 11, wherein
the corrected image is displayed on an entire area of the display area.

22. The display apparatus according to claim 11, wherein
the corrected image is displayed exclusively in a predetermined part of the display area.

23. The display apparatus according to claim 22, wherein
the predetermined part of the display area has a relatively large amount of cumulative luminance deterioration compared to a remainder of the display area.

24. The display apparatus according to claim 11, wherein
the corrected image is displayed as one of a still image and a moving image.

25. An electronic apparatus comprising the display apparatus of claim 11.

26. A head mounted display apparatus comprising an eyeglass type frame mountable to a user's head and the display apparatus of claim 1 connected to the eyeglass type frame.

27. The head mounted display apparatus of claim 26, further comprising:
a sensor configured to sense whether the head mounted display apparatus is mounted to a user's head in a position for normal image display, and
a control unit configured to control which of the normal image and the correction image is displayed based on the sensor's output such that the correction image is displayed only in a period in which the display apparatus is not mounted to a user's head in a position for normal image display.

28. A display apparatus, comprising:
a display unit that includes a display area including display elements arranged in a two-dimensional matrix and is configured to display an image in the display area based on a display signal, the display elements each including a current-drive-type light-emitting unit, the display signal being a video signal when a normal image is displayed and being a correction signal when a correction image is displayed to equalize a degree of luminance deterioration of the display elements; and
a correction signal generation unit configured to:
determine a cumulative luminance deterioration amount for each of the display elements based on values of the display signal for the respective display element and on one or more corresponding luminance deterioration functions;
generate the correction signal based on the cumulative deterioration amounts such that display of the correction image accelerates luminance deterioration for those display elements having a small cumulative luminance deterioration amount and slows down or stops luminance deterioration for those display elements having a large cumulative luminance deterioration amount.

29. A display apparatus, comprising:
a display unit that includes a display area including display elements arranged in a two-dimensional matrix and is configured to display an image in the display area based on a display signal, the display elements each including a current-drive-type light-emitting unit, the display signal being a video signal when a normal image is displayed and being a correction signal when a correction image is displayed to equalize a degree of luminance deterioration of the display elements; and
a correction signal generation unit configured to:
update a cumulative luminance deterioration value for each of the display elements when a value of the display signal is input to the respective display element by:
determining an incremental luminance deterioration value for the respective display element based on the display signal and on one or more corresponding luminance deterioration functions; and
incrementing the cumulative luminance deterioration value for the respective display element by the incremental luminance deterioration value for the respective display element; and
generate the correction signal based on the cumulative deterioration values such that display of the correction image accelerates luminance deterioration for those display elements having a small cumulative luminance deterioration value and slows down or stops luminance deterioration for those display elements having a large cumulative luminance deterioration value.

30. A display apparatus, comprising:
a display unit that includes a display area including display elements arranged in a two-dimensional matrix and is configured to display an image in the display area based on a display signal, the display elements each including a current-drive-type light-emitting unit, the display signal being a video signal when a normal image is displayed and being a correction signal when a correction image is displayed to equalize a degree of luminance deterioration of the display elements; and
a correction signal generation unit configured to determine a cumulative luminance deterioration amount for each of predetermined regions of the display area and generate the correction signal based on the cumulative deterioration amounts such that display of the correction image accelerates luminance deterioration for the display elements in those predetermined regions having a small cumulative luminance deterioration amount and slows down or stops luminance deterioration for the display elements of those predetermined regions having a large cumulative luminance deterioration amount.

31. An electronic apparatus comprising:
a display unit including a display area; and
a battery unit,
wherein the display area is configured to display a normal image and a correction image, and
wherein the correction image is displayed during charging the battery unit.

32. The electronic apparatus of claim 31, wherein the display unit is an electronic viewfinder using an organic EL display element.

33. The electronic apparatus of claim 32, wherein a video signal for display of the normal image is sent to the display unit when the user looks through the electronic viewfinder, and a correction signal for display of the correction image is sent to the display unit when the user does not look through the electronic viewfinder.

34. The electronic apparatus of claim 32, wherein the display area includes at least a first part and a second part which is more deteriorated than the first part, and the correction image is formed such that the first part of the display area displays higher luminance than the second part of the display area.

35. The electronic apparatus of claim 31, further comprising:
a sensor configured to sense a user, and
a control unit configured to control which of the normal image and the correction image is displayed based on the sensor's output.

36. The electronic apparatus of claim 35, wherein the sensor is arranged near the display unit to be able to detect a user.

37. The electronic apparatus of claim 31 further comprising:
a control unit configured to supply a display signal to the display unit; and
a sensor configured to supply a detection signal to the control unit,
wherein the display unit is configured to display an image in the display area based on a display signal that is a video signal when the normal image is displayed and a correction signal when the correction image is displayed, and
wherein the control unit is configured to switch the display signal between the video signal and the correction signal and the display area is configured to change between displaying the normal image and displaying the correction image based on the detection signal.
